(19) United States
(12) Patent Application Publication
(10) Pub. No.: US 2003/0010386 A1
(43) Pub. Date: Jan. 16, 2003

(54) Flow control device and method of installation

(76) Inventor: Serge J. Doyen, Essex, CT (US)

Correspondence Address: Philip J. Lee, Suite 525, 10050 Regency Circle, Omaha, NE, 68114, US

(21) Appl. No.: 10/165,118

(22) Filed: Jun. 7, 2002

Related U.S. Application Data
(60) Provisional application No. 60/297,232, filed on Jun. 8, 2001.

(51) Int. Cl. F16K 15/00

(52) U.S. Cl. 137/515

(57) ABSTRACT

A flow control device for installation in a bore in a compliant housing comprises a central flow control mechanism and generally cylindrical body with an outer surface having a base diameter and comprising a plurality of annular ridges, coaxial with the device, arrayed in an axial series and separated by grooves, and projecting radially outward above the base diameter of the device, and a method of securing a flow control device within a bore formed in a compliant housing, comprises the steps of forming the outer surface of the device to have a generally cylindrical shape and a base diameter and comprising a plurality of annular ridges, coaxial with the device, arrayed in an axial series, separated by grooves and projecting radially outward above the base diameter of the device, the base diameter formed or selected to be slightly less than the inside diameter of the bore, and pressing the device into the bore to the desired location at a rate not exceeding the rate at which the material of the housing displaced by the ridges can flow into the grooves.

### CROSS REFERENCE TO RELATED PROVISIONAL APPLICATION

This application claims the benefit of U.S. Provisional Application No. 60/297,232, filed Jun. 8, 2001.

### BACKGROUND OF THE INVENTION

A. Field of Invention

The present invention relates generally to flow control devices for insertion in hydraulic or pneumatic systems and the method of installing such devices in such systems.

B. Description of Related Art

In a variety of pneumatic and hydraulic systems, it is necessary to prevent or control flow into, out of or through a bore, which may be an orifice or passageway formed in a housing. To perform such functions, it is frequently useful to employ flow control devices, which can be easily installed in a bore. A number of design strategies have been utilized to anchor an inserted device within a bore, including generally screw threads, radial expansion mechanisms and barbed configurations. The use of screw threaded devices is limited by inherent complications such as leakage caused by the necessity of a sliding fit, the need for precise cutting of the bore to form threads, the necessity of applying rotational force, and the tendency to back out, particularly when exposed to vibration and pressure. Threaded devices employing design strategies to circumvent these limitations are often relatively intricate and therefore expensive to manufacture and use.

Another common method for retention uses controlled radial expansion of some or all the outer surface of the device to increase the friction and/or interference between the device surface and the inner wall of the installation bore. The result of the increased friction or interference caused by the radial expansion is to prevent axial movement and thereby anchor the inserted device. An example of an insert used as a plug appears in U.S. Pat. No. 2,821,323 to Lee II and an example of radial expansion used to secure a device in a bore appears in U.S. Pat. No. 5,023,990 to Lee II. The radial expansion devices are particularly useful when used with relatively hard housing materials since these devices do not necessarily rely on the cold flow of the housing material. While such devices may cause some deformation of the inner wall of the installation bore, they do not rely on the elasticity or plasticity of the housing material to the extent of barbed devices, which use asymmetrical radial protrusions on the exterior of the insert to secure the device.

Barbed devices such as are shown in U.S. Design Pat. No. 289,374 to Zlaylek and in U.S. Pat. No. 3,834,438 to Zlaylek are designed for insertion into soft, elastic and plastic housing materials, e.g., thermoplastic or wood. Due to the soft nature of the housing materials into which barbed inserts are installed, the usual barb configuration relies on a relatively wide radial protrusion above the surface of the insert into the housing. The degree of radial protrusion of the barb structures require the inner wall of the installation bore to significantly expand on insertion of the barbed insert, and the bore expansion is accomplished by a gradual sloping forward surface. As seen in the Zlaylek devices, barb protrusions are frequently not annular and provide little, if any sealing of the installation bore. The retention of the barbed insert is accomplished by the steep back surface of the barbs, which contact the portion of the bore wall, which resumes some or all its original diameter after passing the widest point of the barbs. The pitch of the back surface of the barbs is great enough relative to the direction of the withdrawal force that the bore wall can not expand to allow the retraction of the barb, thus anchoring the insert in the housing. Extraction of the barbed insert does not generally involve the flow of the housing material back over the steep back surface of the barb and is inhibited by the physical integrity and shear strength of the housing material rather than friction and resistance to flow. Therefore, the removal of the barbed insert generally results in the forcible tearing of some or all of the housing material that has flowed around the barbs. Thus, the use of barbed inserts is only possible if the housing is deformable and the result of installation and subsequent extraction of the insert is the permanent deformation of the installation bore, which may adversely effect reuse of the bore, which may be permanently unuseable or require significant enlargement in order to be useable after the removal of a barbed insert. In addition, conventionally barbed inserts can only be installed in one direction, which limits usefulness and may complicate installation, as the inserts must first be properly aligned. Installation of both barbed and radial expansion devices generally require significant axial force imparted either by direct impact or through application of rotational force in the case of the devices where the expansion member is screwed in the expanding surface. As noted earlier, the use of screw threads raises the necessity of adding features to prevent the unscrewing of the device, which complicates the structure, raising the cost to manufacture.

A need exists for a method of installing hydraulic or pneumatic system inserts which provides for installation in a bore in a housing with the ability of being installed in either direction and capable of removal without damage to the installation bore and insertion devices capable of being so installed. Further, it is desirable that the inserted device be secured against pressure and seal the installation bore. An insert device that meets these conditions and is economic to manufacture, easy to install, and useful in a wide range of applications would be desirable.

### SUMMARY OF THE INVENTION

The invention herein described is a new hydraulic or pneumatic system insert device for installation in a bore, which may be an orifice or bore in a housing or the bore of a tubular passageway. The device of the present invention is generally cylindrical having two ends and an outer surface that is rippled with a series of annular ridges, coaxial with the device as a whole, longitudinally arrayed on the radially outer surface thereof. The ends of the radially outer surface are cylindrical and are of reduced diameter relative to the diameter of the ridges. The ridges are separated by grooves that reduce the outside diameter to about the same diameter as the end surfaces, the diameter of the end surfaces and grooves being sometimes herein referred to as the base diameter or base surface for ease of description. The ridges are relatively low and wide when viewed in longitudinal cross section, the ratio of height to width being about 1 to 11, and the transition from the top of the ridges to the base surface is gradual, sloping at about 20 degrees. The outside diameter of the end surfaces and grooves is about 95 percent of the outside diameter of the tops of the ridges. The tops of the ridges appear flat in longitudinal cross section view, being in the shape of the outer surface of a cylinder that is coaxial with and of slightly greater diameter than the rest of the device. Each ridge has a ramp section at both axial ends and a flat, or slightly rounded, top section, between the two ramp sections. The ridges are separated from each other by annular grooves, the sides of which form front and back ramp sections of adjacent ridges. The ramp sections nearest the ends of the device slope away from the device ends, and the inner ramp sections form the sides of the grooves including an angle of about 140 degrees. At the both ends of the device, the annular edge of the outer surface of the device, at the juncture of the radially outer surface with the generally flat end surface, is radiused to form a rounded edge. The transitions from the ramp sections to the flattened top section of the ridges may be rounded as well. The radially outer surface of the device is symmetrical about the axis of the device and bilaterally symmetrical across the midpoint between the two ends. As a result of the symmetry of the outer surface, the device can be installed in either direction with either end being the leading end and either set of ramp sections being the leading ridge surface.

The interior of the device may be configured to impart the desired flow control characteristics directly, or may be shaped to accept a separate flow control mechanism, depending upon the intended use of the device. Typical anticipated applications involve the use of the device as a relief or check valve or other hydraulic or pneumatic components such as flow restrictors, nozzles, plugs or screens. Unless the device is to be used as a plug, a flow passage is formed, extending axially through the interior of the device. The flow passage may be central and coaxial with the device as a whole. In addition it may be useful to provide a shoulder and a reduced inner diameter section to facilitate securing a flow control valve or other mechanism within the passageway. Securing the valving mechanism proximate to an area of reduced outside diameter can assist in isolating the mechanism from compression upon installation.

An insert device having the described configuration of the outer surface can be pressed into a bore or orifice in a housing formed of material having some elasticity. The installation bore should have an inside diameter that is equal or slightly greater than the outside diameter of the reduced diameter end sections of the device and that is less than the outside diameter of the ridges, thereby causing an interference fit with the ridges in the bore. The installation bore may include a shoulder to limit the inward progression of the device, when precise location of the device within the bore is required; however, such a shoulder is not otherwise required. The device is preferably installed in such a bore by being pressed toward the desired final installation location in one continuous motion and with sufficient force to advance the device relatively rapidly. The actual molecular distortion of the housing on installation has not been verified; however, it is believed that the at least, and possibly only, the leading ramp section of the first ridge to enter the bore acts to expand the bore temporarily by elastic compression of the housing material, which may only partially recover before the succeeding ridges advance into the bore to their respective final installation locations. When the movement of the device stops or slows sufficiently, the housing material is expected to expand into the grooves to recover some or all of its original diameter. The speed and degree of restitution of the initial bore diameter is expected to vary predictably according to the properties of the housing materials. In addition, it is believed that the friction between the surfaces of the bore and the device is less while the device is moving relative to the bore. Finally, depending of the properties of the housing material, as well as other conditions such as temperature and the degree of compression exerted by the ridges, some cold flow of the housing material into the grooves may occur after the device has come to rest within the bore. It is further expected that the friction between the device and bore surfaces will increase as the device comes to rest. Moving the device from its installation site requires at least initial expansion of the bore by the leading ramp section of each of the ridges. For whatever reason, the force with which the device resists displacement from the installation site is significantly greater than the force required for installation. The low angle of the leading ramp sections and relatively low protrusion of the ridges, cause the wedging force applied by the device against the housing material to compress the housing material to a degree within the elastic tolerance of material, which is not therefore damaged by insertion. The result is that the proper installation of the device does not cause the housing bore to be grooved, scratched, or otherwise marred to prevent creation of a site that may be prone to leak and each ridge will provide an independent seal between the exterior of the device and the installation bore. When the device is configured as a bi-directional component such as a restrictor or nozzle or screen, the device can be installed in either direction without first orienting the device as to which end is to be the leading end. The bilateral symmetry of the device also allows withdrawal of the device to be accomplished also without damage to the installation bore and housing. Since the design installation depends on the elastic nature of the housing, it is noted that the present invention is not suited for brittle housing materials but is suitable for plastics such as nylon based plastic including Dupont, Glass filled reinforced Zytel or Dupont's engineered thermal plastic Minlon. The present invention is useful when used with other housing materials, provided the material is sufficiently elastic to withstand being stretched to the degree required by the amount by which the diameter of the ridges exceeds the base diameter. In the preferred embodiment, the device body is formed of stainless steel, but it will be anticipated that other materials can be used provided they are sufficiently hard relative to the resiliency of the bore housing material, such that the insert is not deformed by the force of installation. The design of devices in accord with the present invention requires consideration of the elastic limits of the housing material relative to the height of the ridges.

The principal aim of the present invention is to provide a new and improved hydraulic or pneumatic component which meets the foregoing requirements and which is capable of being removably installed in a bore in an elastic housing.

Another and further object and aim of the present invention is to provide a new and improved hydraulic or pneumatic component which meets the foregoing requirements and which is economical to manufacture and to provide an economical method of manufacture and installation.

Yet another and further object and aim of the present invention is to provide a new and improved hydraulic or pneumatic component which meets the foregoing requirements and which can be installed in either direction.

Yet another and further object and aim of the present invention is to provide a new and improved method of installing, securing and sealing a hydraulic or pneumatic component which meets the foregoing requirements within a bore in a compliant housing.

Other objects and advantages of the invention will become apparent from the Description of the Preferred Embodiments and the Drawings and will be in part pointed out in more detail hereinafter. The invention consists in the features of construction, combination of elements and arrangement of parts exemplified in the construction hereinafter described and the scope of the invention will be indicated in the appended claims.

### BRIEF DESCRIPTION OF THE DRAWINGS

FIG. 1 is an enlarged, longitudinal section view of a preferred embodiment of a hydraulic system device constructed in accordance with the present invention.

FIG. 2 is an enlarged, longitudinal section view of a preferred embodiment of a hydraulic system device constructed in accordance with the present invention along section line 2-2 shown in FIG. 1.

### DESCRIPTION OF THE PREFERRED EMBODIMENT(S)

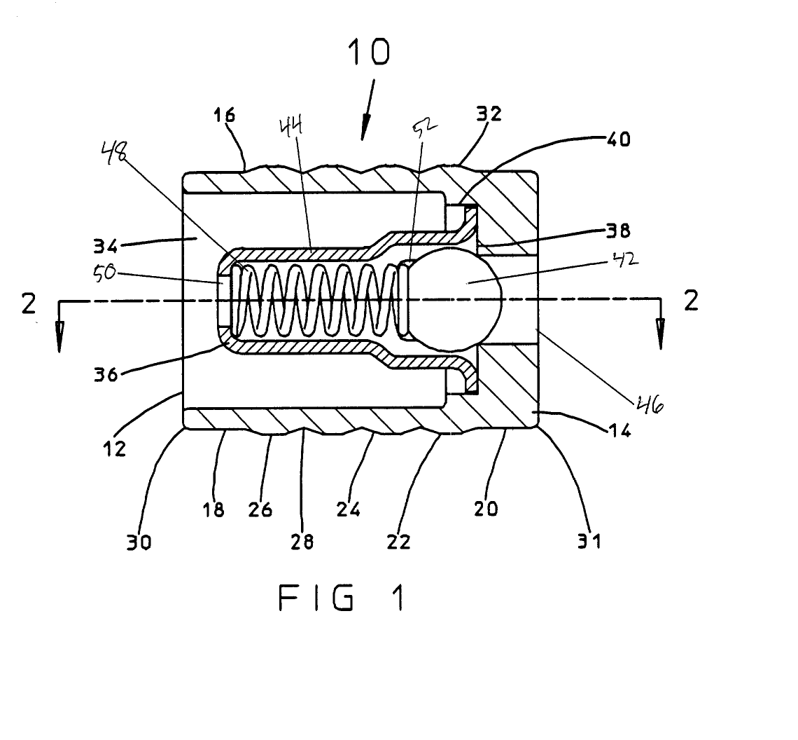

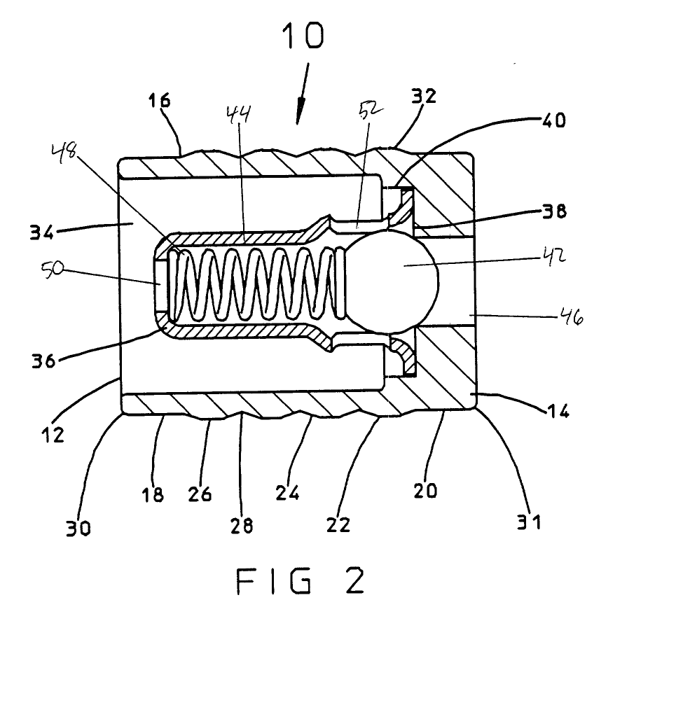

With reference to the Drawings wherein like numerals represent like parts throughout the Figures, a device in accordance with the present invention is generally designated in FIGS. 1, 2, and 3 by the numeral 10. device 10 is generally cylindrical having two ends 12 and 14 and a radially outer surface 16 therebetween. Outer surface 16 comprises two cylindrical surfaces 18 and 20 adjacent ends 12 and 14 respectively. Cylindrical end surfaces 18 and 20 are the same outside diameter, referred to herein as the base diameter. A series of annular, circumferentially extending ridges 22, coaxial with the device 10 as a whole, are longitudinally arrayed on outer surface 16 between cylindrical end surfaces 18 and 20. Each ridge 22 projects radially outward from the base diameter to a ridge top section 26 of greater diameter and has an inclined ramp section 24 at either end with the ridge top section 26 located axially between the two ramp sections 24. The ridge top sections 26 appear flat in longitudinal cross section view, being cylindrical and coaxial with the rest of the device 10. The outside diameter of the ridge top sections 26 may be refered to herein as the ridge diameter. Some or all of the ridge top sections 26 can be alternatively shaped to form a slightly rounded, curved outer surface. Successive ridges 22 are separated from each other by annular grooves 28, the sides of which form front and back ramp sections 24 of the adjacent ridges 22. The diameter of the bottoms of grooves 28 is the same as or similar to the base diameter of the end surfaces 18 and 20.

The projection of ridges 22 above the end surfaces 18 and 20 and the bottom of grooves 28 in the preferred embodiment is illustrated by the fact that the difference between the ridge diameter and the base diameter is about 5 percent of the base diameter. The slope of ramp sections 24 is about 20 degrees from the axis of device 10. Adjacent ramp sections 24 form the sides of grooves 28 and include an angle of about 140 degrees. In the illustrated preferred embodiment, the axial width of the ramp sections 24 is about 70 percent of the axial width of the ridge top sections 26 and the radial projection of the ridges 22 above the end surfaces 18 and 20 and grooves 28 (one half of the difference between the diameter of ridge top section 26 and the base diameter) is about 11 percent of the axial width of ridges 22, measured as the distance between grooves 28. The annular edge 30 of end surface 18 at end 12 and the annular edge 31 of end surface 20 at end 14 are both radiused to form a rounded edge. Each annular transition 32 between a ramp section 24 to the adjacent ridge top section 28 of the ridge may be radiused as well. The radially outer surface 16 of the insert device 10 is bilaterally symmetrical across the midpoint between the two ends 12 and 14, and is rotationally symmetrical about the axis of device 10.

For example only, in a specific exemplar of insert device 10 having a nominal length of 7.26 mm, the nominal outside diameter at the bottom of the grooves 28 and at the end surfaces 18 and 20 (the base diameter) is 5.20 mm, while the greatest diameter point of the ridge top sections 26 (the ridge diameter) has a nominal outside diameter of 5.46 mm. In the same exemplar of device 10, there are four ridges 22 and the distance between the grooves 28, which is the same as the axial length of each ridge 22, is 1.19 mm, the ridge top sections 28 are about 0.51 mm wide, and the axial length of the end surfaces 18 and 20 is 1.26 mm. Thus, in the specific exemplar of device 10, the ridges 22 rise only about 0.13 mm above the grooves 28 and end surfaces 18 and 20, and extend an axial distance of about 1.19 mm.

The interior of insert device 10 forms a flow control passage 34 which may alternatively be configured to accept a flow control mechanism, or to integrally provide the desired flow control. The illustrated preferred embodiment shown in FIG. 1 shows a check valve 36 secured within flow control passage 34. To accept and secure valve 36, a shoulder 38 is formed normal to the axis of device 10 and a reduced diameter section 40 is formed adjacent to shoulder 38. Valve mechanism 36 is axially restrained by interference with shoulder 38 and frictional contact with reduced diameter section 40. Check valve mechanism 36 comprises a ball 42 captured within a cage 44 and biased against a central flow aperture 46 by a spring 48. Cage 44 comprises an end opening 50 and two side openings 52 to allow flow past ball 42 and through device 10 when ball 42 is displaced from aperture 46 by flow pressure. It will be anticipated that other valve or flow control mechanisms could be employed and that other means to secure such mechanisms could be employed, such as welding, gluing, or mechanical means. In some applications, a structurally simple flow control mechanism can be formed directly by the flow passage 34 of device 10. For example, if device 10 was to perform as a plug or nozzle or flow restrictor, aperture 46 would be eliminated or shaped to achieve the desired flow control function.

The method of installation and use of device 10 serves as an example of a more general method of inserting, securing and sealing a device within a bore, and comprises pressing a device with the outer surface of device 10 into a bore or orifice in a housing (not shown) formed of material having sufficient elasticity. The inside diameter of the installation bore is at least equal to and preferably slightly greater than the base diameter of the end section surfaces 18 and 20 and grooves 28, but not as large as the outside diameter of the ridges 22, thereby causing an interference fit between the ridges 22 and the inside wall of the installation bore. The relation of the bore diameter to the device base diameter is controlled by either drilling a slightly larger bore to insert a given device 10 or by selecting an appropriately sized device 10 for insertion into a given bore. As an example, an appropriate installation bore for the specific exemplar of device 10 as described above (ridge diameter: 5.46 mm and base diameter: 5.20 mm), would have a nominal inner diameter of 5.32 mm, whereby the end surfaces 18 and 20 of the device 10 would have a diametric clearance of 0.12 mm within the bore and the ridges 22 would have a diametric interference of 0.14 mm. The installation method of the present invention is suitable for housings formed of plastics such as nylon based plastic including Dupont, Glass filled reinforced Zytel or Dupont's engineered thermal plastic Minlon, with the body of device 10, in the preferred embodiment, being formed of stainless steel, and it will be anticipated that other materials can be used provided they are sufficiently hard relative to the resiliency of the bore housing material, such that the insert is not deformed by the force of installation. The installation of devices similar to device 10 in accord with the present invention requires consideration of the elastic limits of the housing material relative to the height of the ridges. The present invention may be used for installation of such devices in housings of different materials, provided the material is sufficiently elastic to withstand being stretched to the degree required by the amount by which the ridge diameter exceeds the base diameter.

The installation bore may include a shoulder to limit the inward progression of the device 10 and precisely locate the device 10 within the installation bore; however, such a shoulder is not necessarily required. On insertion of a device having an outer surface as described for device 10 into such a bore, the advancing ridge ramp sections 24 displace the housing material to expand the bore, and the displaced housing material will flow back into the grooves 28 and the outer reduced diameter end sections 18 and 20, as the device 10 proceeds into the bore. The device is pressed into the bore to the desired location at a rate not exceeding the rate at which the material of the housing displaced by the ridges can flow into the grooves.

The bilateral symmetry of the device 10 allows withdrawal of the device 10 to be accomplished also without damage to the installation bore and housing. When the device 10 is configured as a bidirectional component such as a restrictor or nozzle or screen, the device 10 can be installed in either direction without first orienting the device 10 as to which end 12 or 14 is to be the leading end

It will be appreciated that while a useful method of manufacturing device 10 is to turn device 10 on a lathe from bar stock, device 10 could alternatively be formed in other ways, such as molding, which might make some modifications to the construction possible or advantageous. For example, the ridge top sections 26 may be economically be rounded in a molded embodiment. In the embodiment illustrated herein, the insert device 10, is economically formed by cutting away the grooves 28 and reduced diameter end sections 18 and 20 while leaving the ridge top sections 28, except as may be necessary to meet the specified diameter. It will further be anticipated that the dimensions quoted herein as examples that are appropriate for the materials and methods of manufacture and installation housing materials as described herein and may be changed without departing from the spirit of the present invention in the event such characteristics and materials are varied. It will be specifically noted that use of harder, less resilient material for the installation bore may require decreasing the projection of the ridges 22 above the base diameter, and/or decreasing the slope of the ramp sections 24. Conversely, softer, more resilient material for the installation bore may require and allow increasing the projection of the ridges 22 above the base diameter, and/or increasing the slope of the ramp sections 24. In addition, it will be further anticipated that as few as two ridges may be used with beneficial results and that the addition of additional ridges in excess of two will result in an increase in the sealing effectiveness of the device. An alternative embodiment to be anticipated may utilize the property of sealing between the ridges to separate or seal flow passages from each other. For example, the ridges could be axially separated and the space between the ramp sections could be used as a port or a part of a flow passage, providing a side port, third port, or multiple ports, for a valve or other flow control mechanism.

While preferred embodiments of the foregoing invention have been set forth for purposes of illustration, the foregoing description should not be deemed a limitation of the invention herein. Accordingly, various modifications, adaptations and alternatives may occur to one skilled in the art without departing from the spirit and the scope of the present invention.

I claim:

1. A flow control device for installation in a bore in a compliant housing, the device comprising a central flow control mechanism and generally cylindrical body with an outer surface having a base diameter and comprising a plurality of annular ridges, coaxial with the device and projecting radially outward above the base diameter of the device.

2. The flow control device of claim 1 wherein the ridges are arrayed in an axial series and separated by grooves.

3. The flow control device of claim 2 wherein the ridges project a height above the base diameter of about 5% of the base diameter.

4. The flow control device of claim 3 wherein each ridge comprises a top section of greatest outside diameter and two inclined transition sections which slope from the base diameter to the top section at an angle of about 20 degrees.

5. The flow control device of claim 4 wherein the flow control mechanism comprises a check valve.

6. The flow control device of claim 4 wherein the flow control mechanism comprises a flow restrictor.

7. The flow control device of claim 4 wherein the flow control mechanism comprises a screen.

8. The flow control device of claim 4 wherein the flow control mechanism comprises a nozzle.

9. The flow control device of claim 4 wherein the flow control mechanism comprises a means for preventing flow through the device.

10. A method of securing a flow control device within a bore formed in a compliant housing, comprising the steps of forming the outer surface of the device to have a generally cylindrical shape and a base diameter and comprising a plurality of annular ridges, coaxial with the device and projecting radially outward above the base diameter of the device, the base diameter formed or selected to be slightly less than the inside diameter of the bore, and pressing the device into the bore to the desired location.

11. The method of claim 10 further comprising arraying the ridges in an axial series, separated by grooves.

12. The method of claim 11 further comprising forming the ridges to project a height above the base diameter of about 5% of the base diameter.

13. The method of claim 12 further comprising forming each ridge with a top section and two inclined transition sections which slope from the base diameter to the top section at an angle of about 20 degrees.

14. A method of securing a flow control device within a bore formed in a compliant housing, comprising the steps of forming the bore and forming the outer surface of the device to have a generally cylindrical shape and a base diameter and comprising a plurality of annular ridges, coaxial with the device, arrayed in an axial series, separated by grooves and projecting radially outward above the base diameter of the device, the base diameter formed or selected to be slightly less than the inside diameter of the bore, and pressing the device into the bore to the desired location at a rate not exceeding the rate at which the material of the housing displaced by the ridges can flow into the grooves.

15. The method of claim 14 further comprising forming the ridges to project a height above the base diameter of about 5% of the base diameter.

16. The method of claim 15 further comprising forming each ridge with a top section and two inclined transition sections which slope from the base diameter to the top section at an angle of about 20 degrees.
